(19) United States
(12) Patent Application Publication
(10) Pub. No.: US 2024/0079979 A1
(43) Pub. Date: Mar. 7, 2024

(54) MOTOR AND VIBRATION REDUCTION CONTROL METHOD THEREFOR, AND CIRCUIT

(71) Applicant: JOHNSON ELECTRIC INTERNATIONAL AG, Murten (CH)

(72) Inventor: Patrick Shui Chung WANG, Hong Kong (CN)

(21) Appl. No.: 18/307,944

(22) Filed: Apr. 27, 2023

Related U.S. Application Data
(63) Continuation of application No. PCT/CN2021/123341, filed on Oct. 12, 2021.

(30) Foreign Application Priority Data
Oct. 27, 2020 (CN) 202011165420.7

(51) Int. Cl. H02P 21/05; H02P 21/22; H02P 27/08

(52) U.S. Cl. CPC H02P 21/05; H02P 21/22; H02P 27/08

(57) ABSTRACT

The disclosure belongs to the field of motors, and discloses a motor vibration reduction control method comprising: step a, determining whether an actual vibration amplitude of the motor exceeds a preset amplitude; step b, if the actual vibration amplitude exceeds the preset amplitude, determining peak time periods and valley time periods of a cogging torque of the motor, and controlling a duty cycle of a pulse signal for driving the motor during the peak time periods to be higher than a duty cycle of the pulse signal during the valley time periods. The motor vibration reduction method of the present disclosure can reduce adverse effect of the cogging torque fluctuation of the motor on the output torque of the motor, thereby reducing the vibration of the motor, prolonging its service life and reducing its noise.

### TECHNICAL FIELD

The disclosure belongs to the field of motors, and in particular relates to a motor and a vibration reduction control method and circuit thereof.

### BACKGROUND TECHNOLOGY

As we all know, cogging torque is one of the unique problems of permanent magnet motors, and it is a key problem that must be considered and solved in the design and manufacture of high-performance permanent magnet motors. Cogging torque is the torque generated by the interaction between the permanent magnet and the stator core when the winding of the permanent magnet motor is not energized, and is caused by the tangential component of the interaction force between the permanent magnet and the armature teeth. The cogging torque will cause the actual output torque of the motor to fluctuate, so that the motor cannot run smoothly, and vibration and noise will be generated, which will affect the performance of the motor.

At high speeds, the inertia and load of the motor can cancel out some of the effects of cogging torque ripple. However, in the case of low speed, the influence of cogging torque fluctuation on the motor is more obvious, especially, when the load of the motor is dynamic, for example, a motor used to drive electric roller blinds, the fluctuation amplitude of cogging torque will be become more severe, causing the motor to vibrate more severely and generate louder noise.

Additionally, motor vibrations attract more pulsating current through the motor coils, causing the motor to overheat, dissipating energy in the form of noise and heat. Long-term motor vibration will also cause shaft alignment problems, bearing problems, etc., and accelerate the aging of the motor structure, which is not conducive to improving the service life of the motor.

### SUMMARY

In view of this, the embodiments of the present disclosure provide a motor and a vibration reduction control method and circuit thereof, so as to improve the problem of motor vibration in the prior art.

The present disclosure provides a motor vibration reduction control method, comprising: step a, determining whether an actual vibration amplitude of the motor exceeds a preset amplitude; step b, if the actual vibration amplitude exceeds the preset amplitude, determining peak time periods and valley time periods of a cogging torque of the motor, and controlling a duty cycle of a pulse signal for driving the motor during the peak time periods to be higher than a duty cycle of the pulse signal during the valley time periods.

The present disclosure further provides a motor vibration reduction control method, comprising: step a, determining whether an actual vibration amplitude of the motor exceeds a preset amplitude; step b, if the actual vibration amplitude exceeds the preset amplitude, determining peak time periods and valley time periods of a cogging torque of the motor, and controlling an intensity of at least one phase current of the motor during the peak time periods to be higher than an intensity that has not been adjusted by the vibration reduction control, and an intensity of at least one phase current of the motor during the valley time periods to be lower than an intensity that has not been adjusted by the vibration reduction control.

The present disclosure further provides a motor vibration reduction control circuit, comprising: a vibration amplitude judging unit, configured to determine whether an actual vibration amplitude of the motor exceeds a preset amplitude according to a signal output by a vibration sensor installed on the motor; and a duty cycle adjustment unit, configured to determine peak time periods and valley time periods of a cogging torque of the motor, and control a duty cycle of a pulse signal for driving the motor during the peak time periods to be higher than a duty cycle of the pulse signal for driving the motor during the valley time periods, when the actual vibration amplitude exceeds the preset amplitude.

The present disclosure further provides a motor vibration reduction control circuit, comprising: a vibration amplitude judging unit, configured to determine whether an actual vibration amplitude of the motor exceeds a preset amplitude according to a signal output by a vibration sensor installed on the motor; and a phase current adjustment unit, configured to determine peak time periods and valley time periods of a cogging torque of the motor, and control an intensity of at least one phase current of the motor during the peak time periods to be higher than an intensity that has not been adjusted by the vibration reduction control, and an intensity of at least one phase current of the motor during the valley time periods to be lower than an intensity that has not been adjusted by the vibration reduction control, when the actual vibration amplitude exceeds the preset amplitude.

The present disclosure further provides a motor, the motor being a brushless direct current motor, comprising a stator wound with a coil, a permanent magnet rotor, a vibration sensor mounted on the stator, an inverter circuit connected to the coil, and an aforementioned motor vibration reduction control circuit.

Compared with the prior art, the motor vibration reduction control method of the present disclosure controls an intensity of at least one phase current of the motor during the peak time periods to be higher than an intensity that has not been adjusted by the vibration reduction control, and an intensity of at least one phase current of the motor during the valley time periods to be lower than an intensity that has not been adjusted by the vibration reduction control, by determining peak time periods and valley time periods of a cogging torque of the motor, thus reducing adverse effect of the cogging torque fluctuation of the motor on the output torque of the motor, thereby reducing the vibration of the motor, prolonging its service life and reducing its noise.

### DESCRIPTION OF THE DRAWINGS

In order to more clearly illustrate the technical solutions in the embodiments of the present disclosure, the following will briefly introduce the accompanying drawings that need to be used in the descriptions of the embodiments or the prior art. Obviously, the drawings in the following description are only some embodiments of the present disclosure, and those skilled in the art can obtain other drawings according to these drawings without any creative effort.

FIG. 1 is a flow chart of a motor vibration reduction control method of a first embodiment of the present disclosure;

FIG. 2 exemplarily shows a waveform diagram of each phase current of a motor under the condition that vibration reduction control is not performed;

FIG. 3(a), (b), (c), (d), (e), and (f) respectively show waveform diagrams of a partial area A′ of the phase currents shown in FIG. 2 after performing the vibration reduction control, a cogging torque and an actual output torque of the motor before performing the vibration reduction control, and an actual output torque of the motor after performing the vibration reduction control;

FIG. 4 is a flowchart of a motor vibration reduction control method of a second embodiment of the present disclosure;

FIG. 5 is a flow chart of a motor vibration reduction control method of a third embodiment of the present disclosure;

FIGS. 6(a) and 6(b) exemplarily show the partial waveform diagrams of a A-phase current and the corresponding waveform diagram of a pulse signal for driving the motor, when the vibration reduction control method of the third embodiment of the present disclosure is used and the motor drives different loads;

FIG. 7 is a block diagram of a motor vibration reduction control circuit provided by a first embodiment of the present disclosure;

FIG. 8 is a block diagram of a motor vibration reduction control circuit provided by a second embodiment of the present disclosure;

FIG. 9 is a schematic block diagram of a motor of a preferred embodiment of the present disclosure;

FIG. 10 is a block diagram of a motor vibration reduction control circuit provided by a third embodiment of the present disclosure.

### DETAILED EMBODIMENTS

In the following description, specific details such as specific system structures and technologies are presented for the purpose of illustration rather than limitation, so as to thoroughly understand the embodiments of the present disclosure. It will be apparent, however, to one skilled in the art that the disclosure may be practiced in other embodiments without these specific details. In other instances, detailed descriptions of well-known systems, devices, circuits, and methods are omitted so as not to obscure the description of the present disclosure with unnecessary detail.

In order to illustrate the technical solutions of the present disclosure, the following will be described through specific examples.

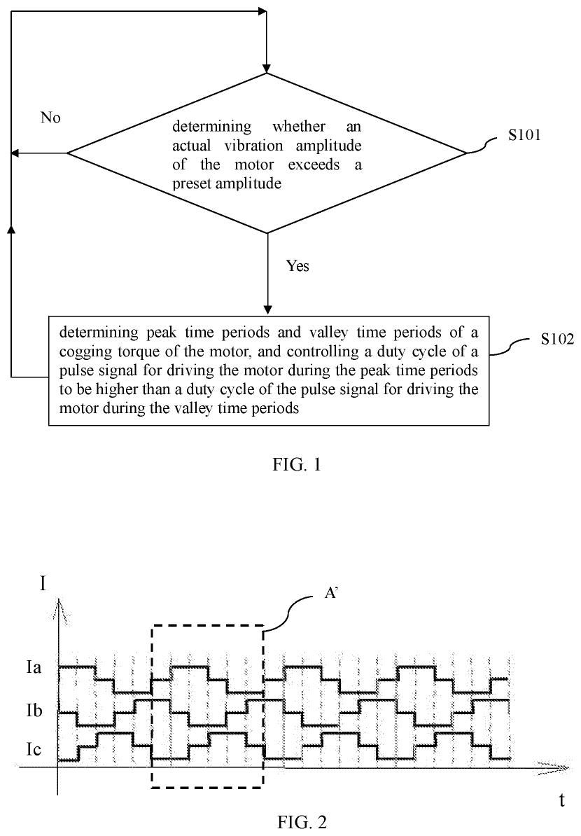

FIG. 1 is a flowchart of a motor vibration reduction control method of a first embodiment of the present disclosure, the motor vibration reduction control method of the first embodiment includes the following steps:

Step S101, determining whether an actual vibration amplitude of the motor exceeds a preset amplitude.

The motor may be a three-phase BLDC (brushless direct current motor), and a vibration sensor may be installed on a stator of the motor, for example on a housing or a bearing. The step S101 may be determined according to a waveform output by the vibration sensor. The vibration sensor is preferably an accelerometer, and may also be any sensor that can reflect the actual vibration amplitude of the motor, such as a speed sensor or a displacement sensor. The vibration sensor is kept in good contact with the motor, and a detection head can be installed by using a magnetic base, welding or punching a hole on the motor, and screwing it with a thread.

The vibration sensor may output a periodic waveform having peaks and valleys. In this embodiment, whether the actual vibration amplitude of the motor exceeds the preset amplitude is determined by judging whether the fluctuation amplitude of the waveform output by the vibration sensor exceeds a preset value. The fluctuation amplitude of the waveform output by the vibration sensor can be any value that can represent the fluctuation amplitude, such as the amplitude value, peak-to-peak value or effective value of the waveform. The preset value is a critical value which is set to be corresponding to the amplitude value, peak-to-peak value, or effective value and the like.

That is, if the fluctuation amplitude of the waveform output by the vibration sensor exceeds the preset value, the actual vibration amplitude of the motor exceeds the preset amplitude, and the vibration degree of the motor is relatively serious; otherwise, the actual vibration amplitude of the motor does not exceed the preset amplitude, and the vibration degree of the motor is acceptable.

In other embodiments, the step S101 can also be determined by detecting the waveform of the actual current flowing through the motor coil. For example, the corresponding relationship between the current flowing through the motor coil and the vibration amplitude of the motor can be established in advance according to statistical analysis, neural grid training or fuzzy logic, and stored in a look-up table in advance.

Step S102, if yes, determining peak time periods and valley time periods of a cogging torque of the motor, and controlling a duty cycle of a pulse signal for driving the motor during the peak time periods to be higher than a duty cycle of the pulse signal for driving the motor during the valley time periods.

Specifically, the peak time periods and valley time periods of a cogging torque of the motor can be determined through the waveform output by the vibration sensor. Preferably, when the vibration sensor installed on the motor is an accelerometer, the accelerometer may output a waveform in phase or in phase opposite to that of the cogging torque of the motor, depending on the type of the accelerometer.

The peak time period refers to a period of time when the cogging torque of the motor is greater than a first preset value, and the valley time period refers to a period of time when the cogging torque of the motor is smaller than a second preset value. The first preset value is greater than or equal to the second preset value.

Compared with the prior art, the motor vibration reduction control method of the present disclosure controls a duty cycle of a pulse signal for driving the motor during the peak time periods to be higher than a duty cycle of the pulse signal for driving the motor during the valley time periods, by determining peak time periods and valley time periods of the cogging torque of the motor, thus reducing adverse effect of the cogging torque fluctuation of the motor on the output torque of the motor, thereby reducing the vibration of the motor, prolonging its service life and reducing its noise.

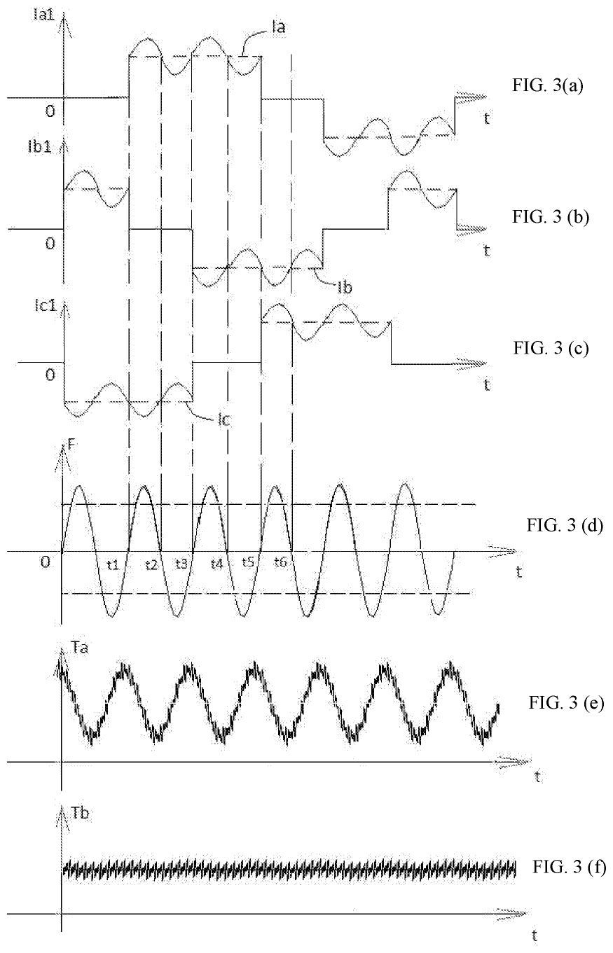

The following takes a three-phase brushless direct current motor installed with an accelerometer as an example to illustrate how to adjust the duty cycle of the pulse signal for driving the motor. FIG. 2 exemplarily shows a waveform diagram of each phase current of a motor under the condition that vibration reduction control is not performed, wherein Ia, Ib, and Ic represent A-phase current, B-phase current, and B-phase current, respectively. FIG. 3(a), (b), (c), (d), (e), and (f) respectively show waveform diagrams of a partial area A′ of the phase currents shown in FIG. 2 after performing the vibration reduction control, a cogging torque F and an actual output torque Ta of the motor before performing the vibration reduction control, and an actual output torque Tb of the motor after performing the vibration reduction control.

Referring to FIG. 3(d), assuming that the first preset value and the second preset value in the above step S102 are zero, the change of the phase currents within the period t1-t6 is taken as an example for illustration. At time t1, the cogging torque of the motor begins to increase, and the time period t1-t2 is the peak time period of the cogging torque, during this period, the duty cycle of the pulse signal for driving the motor is increased, making magnitudes of the A-phase current and the C-phase current respectively higher than the current values Ia and Ic that have not been adjusted by the vibration reduction control; at time t2, the cogging torque of the motor begins to decrease, and the time period t2-t3 is the valley time period of the cogging torque, during this period, the duty cycle of the pulse signal for driving the motor is reduced, making magnitudes of the A-phase current and the C-phase current respectively lower than the current values Ia and Ic that have not been adjusted by the vibration reduction control; at time t3, the cogging torque of the motor begins to increase again, and the time period t3-t4 is the peak time period of the cogging torque, during this period, the duty cycle of the pulse signal for driving motor is increased, making magnitudes of the A-phase current and the B-phase current respectively higher than the current values Ib and Ic that have not been adjusted by the vibration reduction control; at time t4, the cogging torque of the motor begins to decrease again, and the time period t4-t5 is the valley time period of the cogging torque, during this period, the duty cycle of the pulse signal driving the motor is reduced, making magnitudes of the A-phase current and the B-phase current respectively lower than the current values Ia and Ib that have not been adjusted by the vibration reduction control; at time t5, the cogging torque of the motor begins to increase again, and the time period t5-t6 is the peak time period of the cogging torque, during this period, the duty cycle of the pulse signal for driving the motor is increased, making the magnitudes of the B-phase current and the C-phase current respectively higher than the current values Ib and Ic that have not been adjusted by the vibration reduction control, and the follow-up control can refer to waveform diagrams of FIG. 3, and will not be repeated here.

Comparing FIG. 3(e) and FIG. 3(f), it can be seen that after the pulse signal is adjusted, the fluctuation of the output torque Tb of the motor becomes stable, so the vibration of the motor is improved.

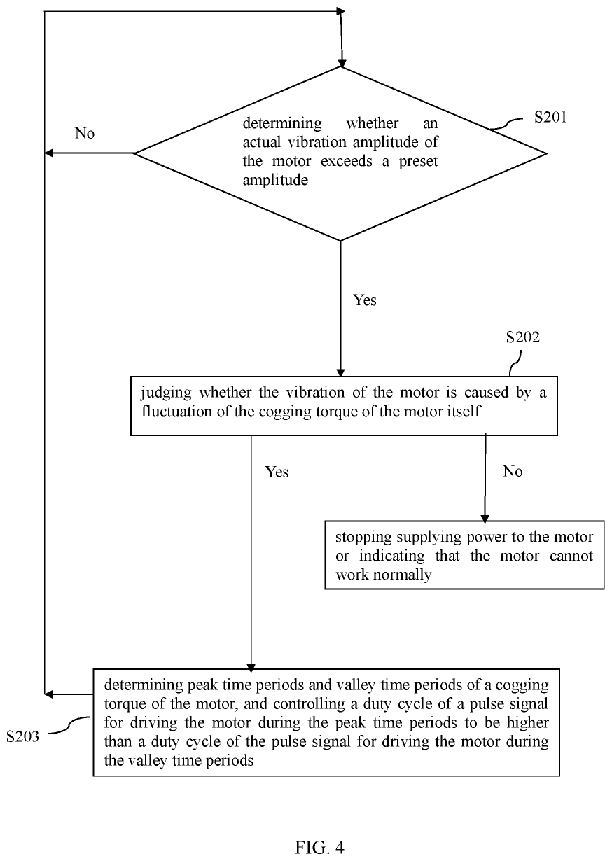

FIG. 4 is a flowchart of a motor vibration reduction control method of a second embodiment of the present disclosure. The motor vibration reduction control method in this embodiment includes the following steps:

Step S201, determining whether the actual vibration amplitude of the motor exceeds a preset amplitude.

The step S201 is the same as the step S101 of the aforementioned motor control method, and will not be repeated here.

Step S202, if yes, judging whether the vibration of the motor is caused by a fluctuation of the cogging torque of the motor itself.

Preferably, the step S202 further includes the following step: if the actual vibration amplitude does not exceed the preset amplitude, return to the step S201.

In the step S202, whether the vibration of the motor is caused by the fluctuation of the cogging torque of the motor itself can be determined by determining whether an actual vibration frequency F of the motor matches a preset frequency Ft. Specifically, if the actual vibration frequency F of the motor matches the preset frequency Ft, the vibration of the motor is caused by the fluctuation of the cogging torque of the motor. Otherwise, the vibration of the motor may be caused by other factors such as mechanical damage or aging.

Specifically, if the actual vibration frequency F of the motor is within a fluctuation range of 15% of the preset frequency Ft, that is, (1-15%) Ft≤F≤(1+15%)Ft, the two are considered to match.

The actual vibration frequency F of the motor may be a frequency presented by the waveform output by the vibration sensor installed on the motor. The preset frequency Ft may be a frequency presented by the waveform output by the vibration sensor installed on the motor or the same batch of motors when the motor leaves the factory. The vibration sensor used to obtain the above-mentioned actual vibration frequency F and the vibration sensor used to obtain the preset frequency Ft are preferably the same vibration sensor, or vibration sensors that can output waveforms of the same phase or reverse phase. For example, when the vibration sensor that obtains the actual vibration frequency F is an accelerometer, and the vibration sensor that obtains the preset frequency Ft is preferably an accelerometer or a torque meter; when the vibration sensor that obtains the actual vibration frequency F is a displacement sensor or a speed sensor, the vibration sensor that obtains the preset frequency Ft is preferably a corresponding displacement sensor or speed sensor.

In other embodiments, the step S202 can judge whether the vibration of the motor is caused by the fluctuation of the cogging torque of the motor itself, by determining whether a number of peak waves, a number of valley waves, or a sum of the two of the actual vibration of the motor within a predetermined period of time matches a corresponding preset number of peak waves, a preset number of valley waves, or a preset sum of the two. Specifically, if matched, the vibration of the motor is caused by the fluctuation of the cogging torque of the motor. Otherwise, the vibration of the motor may be caused by other factors such as mechanical damage or aging.

Specifically, if the number of peak waves a, the number of valley waves b, or the sum of the two c of the actual vibration of the waveform output by the vibration sensor within the predetermined period of time falls within a fluctuation range of 15% of the preset number of peak waves a1, the preset number of valley waves b1, or the preset sum of the two c1, that is, (1-15%) a1≤a≤(1+15%)a1, (1-15%) b1≤b≤(1+15%)b1 or (1-15%) c1≤c≤(1+15%)c1, the two are considered to match.

The predetermined period of time may be, but is not limited to, a duration of one electrical cycle of the motor. When the motor is a brushless direct current motor, a complete mechanical cycle of the motor is n times an electrical cycle, wherein n=half of the number of rotor poles.

The number of peak waves a, the number of valley waves b or the sum of the two c of the actual vibration may be a number of peak waves, a number of valley waves or the sum of the two presented by the waveform output by the vibration sensor installed on the motor within the predetermined period of time. The corresponding preset number of peak waves a1, preset number of valley waves b1, and the sum c1 of the preset number of peak waves and number of valley waves may be a number of peak waves, a number of valley waves, and a sum of the two presented by the waveform output by the vibration sensor installed on the motor or the same batch of motors when the motor leaves the factory. Similarly, the vibration sensor used to obtain the number of peak waves a, the number of valley waves b or the sum c of the two and the vibration sensor used to obtain the preset number of peak waves a1, the preset number of valley waves b1, the sum c1 of the preset number of peak waves and number of valley waves are preferably the same vibration sensors, or vibration sensors that can output waveforms of the same phase or reverse phase.

It can be understood that the judging method of step S202 is not limited to the above-mentioned embodiments, and can also be determined by detecting a frequency of the actual current flowing through the motor coil. For example, according to statistical analysis, neural grid training or fuzzy logic, the corresponding relationship between the frequency of the current flowing through the motor coil and the vibration frequency of the motor is pre-established and stored in a look-up table.

Step S203, if the vibration of the motor is caused by the fluctuation of the cogging torque of the motor itself, determining peak time periods and valley time periods of a cogging torque of the motor, and controlling a duty cycle of a pulse signal for driving the motor during the peak time periods to be higher than a duty cycle of the pulse signal for driving the motor during the valley time periods.

The step S203 is the same as the step S301 of the aforementioned motor control method, and will not be repeated here.

Preferably, the step S203 further includes the following step: if the vibration of the motor is not caused by the fluctuation of the cogging torque of the motor itself, stop supplying power to the motor or indicating that the motor cannot work normally.

The motor vibration reduction control method of the second embodiment further introduces the step S202, in the case that the vibration of the motor is caused by the fluctuation of the cogging torque of the motor itself, the duty cycle of the pulse signal is adjusted to improve the vibration of the motor, to avoid ineffective adjustment of the duty cycle of the pulse signal.

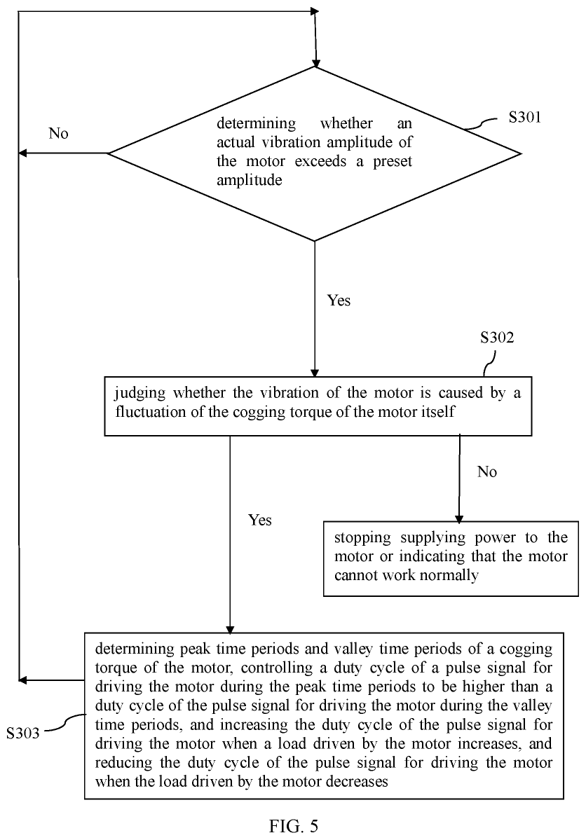

Please refer to FIG. 5, which is a flowchart of a motor vibration reduction control method of a third embodiment of the present disclosure. The motor vibration reduction control method in this embodiment is specially applicable to an occasion where the motor drives a dynamic load. For example, when the load driven by the motor is a rolling shutter, the load changes. The vibration reduction control method of this embodiment includes the following steps:

Step S301, determining whether the actual vibration amplitude of the motor exceeds a preset amplitude.

Step S302, if yes, judging whether the vibration of the motor is caused by the fluctuation of the cogging torque of the motor itself; otherwise, return to the step S301.

Step S303, if the vibration of the motor is caused by the fluctuation of the cogging torque of the motor itself, determining peak time periods and valley time periods of a cogging torque of the motor, controlling a duty cycle of a pulse signal for driving the motor during the peak time periods to be higher than a duty cycle of the pulse signal for driving the motor during the valley time periods; and increasing the duty cycle of the pulse signal for driving the motor when a load driven by the motor increases, and reducing the duty cycle of the pulse signal for driving the motor when the load driven by the motor decreases.

It can be understood that the vibration reduction control method may not include the step S302, and when the actual vibration amplitude of the motor exceeds the preset amplitude, directly enter the step S303 to determine peak time periods and valley time periods of the cogging torque of the motor, and perform follow-up control.

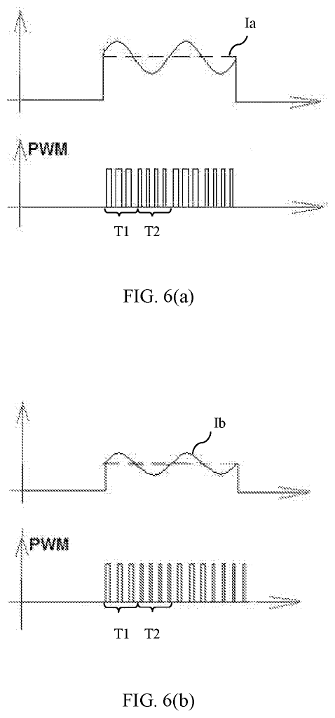

Please refer to FIGS. 6(a) and 6(b), which exemplarily show the partial waveform diagrams of a A-phase current and the corresponding waveform diagram of a pulse signal for driving the motor, when the vibration reduction control method of the third embodiment of the present disclosure is used and the motor drives different loads.

Both the pulse signals in FIGS. 6(a) and 6(b) have two periods, the period T1 corresponds to the aforementioned peak time period of the cogging torque, and the period T2 corresponds to the aforementioned valley peak time period of the cogging torque. The duty cycle of the pulse signal in the period T1 is higher than the duty cycle of the pulse signal in the period T2. FIG. 6(a) shows the case of relatively large load, and FIG. 6(b) shows the case of relatively small load. It can be seen that the duty cycles of the periods T1 and T2 of the pulse signal in FIG. 6(b) are respectively lower than the duty cycles of the periods T1 and T2 of the pulse signal in FIG. 6(a), so the current in FIG. 6(b) fluctuates around a current value Ib, and the current in FIG. 6(a) fluctuates around a current value Ia which is higher than Ib.

The motor vibration reduction control method of this embodiment can adjust the duty cycle of the pulse signal for driving the motor accordingly when the load of the motor changes dynamically, so as to further avoid the motor vibration caused by the load change.

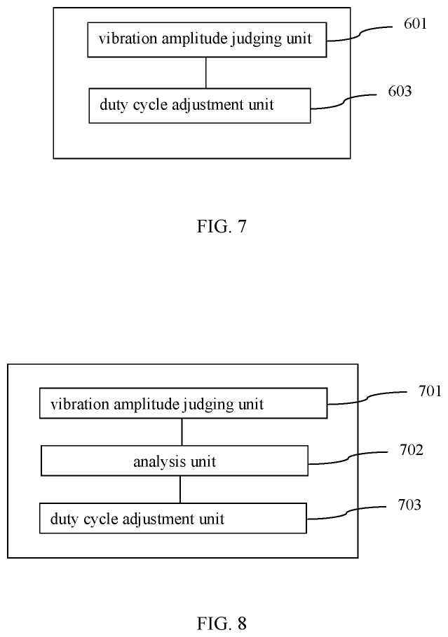

Please refer to FIG. 7, which is a circuit block diagram of a motor vibration reduction control circuit provided by a first embodiment of the present disclosure. The motor vibration reduction control circuit includes:
a vibration amplitude judging unit 601, configured to determine whether an actual vibration amplitude of the motor exceeds a preset amplitude according to a signal output by a vibration sensor installed on the motor; and
a duty cycle adjustment unit 603, configured to determine peak time periods and valley time periods of a cogging torque of the motor, and control a duty cycle of a pulse signal for driving the motor during the peak time periods to be higher than a duty cycle of the pulse signal for driving the motor during the valley time periods, when the actual vibration amplitude of the motor exceeds the preset amplitude.

Please refer to FIG. 8, which is a circuit block diagram of a motor vibration reduction control circuit provided by a second embodiment of the present disclosure. The motor vibration reduction control circuit includes:
a vibration amplitude judging unit 701, configured to determine whether an actual vibration amplitude of the motor exceeds a preset amplitude according to a signal output by a vibration sensor installed on the motor;
an analysis unit 702, configured to judge whether the vibration of the motor is caused by the fluctuation of the cogging torque of the motor itself when the actual vibration amplitude of the motor exceeds the preset amplitude; and
a duty cycle adjustment unit 703, configured to determine peak time periods and valley time periods of a cogging torque of the motor, and control a duty cycle of a pulse signal for driving the motor during the peak time periods to be higher than a duty cycle of the pulse signal for driving the motor during the valley time periods, when the vibration of the motor is caused by the fluctuation of the cogging torque of the motor itself.

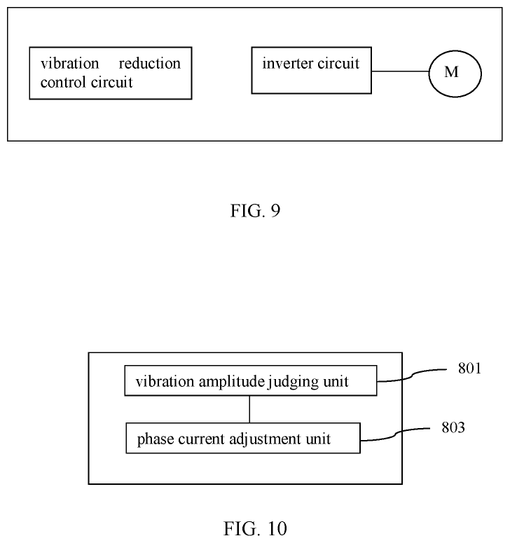

Referring to FIG. 9, the present disclosure also provides a brushless direct current motor, the motor M includes a stator (not shown) wound with coils, a permanent magnet rotor (not shown), and a vibration sensor installed on the stator (not shown), an inverter circuit connected to the coil, and the motor vibration reduction control circuit as described above in FIG. 6 or FIG. 7. The duty cycle adjustment unit 603 or 703 of the vibration reduction control circuit is configured to output pulse signals to the inverter circuit, so as to drive the brushless direct current motor. The brushless direct current motor is preferably but not limited to a three-phase brushless direct current motor, for example, it may also be a single-phase brushless DC motor.

The motor vibration reduction control methods of the first to third embodiments disclose that adjust intensity of at least one phase current by controlling the duty cycle of the pulse signal received by the inverter circuit of the motor, making an intensity of at least one phase current of the motor during the peak time periods of the cogging torque of the motor higher than an intensity that has not been adjusted by the vibration reduction control, and an intensity of at least one phase current of the motor during the valley time periods of the cogging torque of the motor lower than an intensity that has not been adjusted by the vibration reduction control.

Adjusting intensity of at least one phase current refers to adjusting the intensity of the phase current whose intensity is not zero. If the intensity of the phase current is zero, that is, there is no phase current, no adjustment is performed. For example, see FIG. 3, the time period t1-t2 is the peak time period of the cogging torque of the motor, during this period, there is no B-phase current, so only the A-phase and C-phase currents are adjusted to make the A-phase current and C-phase current higher than the current values Ia and Ic that have not been adjusted by the vibration reduction control; the time period t4-t5 is the valley time period of the cogging torque of the motor, during this period, there is no C-phase current, so only the A-phase current and B-phase current are adjusted to make the A-phase current and B-phase current lower than the current values Ia and Ib that have not been adjusted by the vibration reduction control.

It can be understood that the present disclosure can also adjust the intensity of at least one phase current in other ways. For example, the descriptions in the steps S102, S203 and S303 in the motor vibration reduction control methods of the first to third embodiments that “determining peak time periods and valley time periods of a cogging torque of the motor, and controlling a duty cycle of a pulse signal for driving the motor during the peak time periods to be higher than a duty cycle of the pulse signal for driving the motor during the valley time periods” can be replaced with “determining peak time periods and valley time periods of a cogging torque of the motor, and controlling a voltage amplitude of a direct current bus voltage received by an inverter circuit during the peak time periods to be higher than an amplitude that has not been adjusted by performing the vibration reduction control, and a voltage amplitude of the direct current bus voltage during the valley time periods lower than an amplitude that has not been adjusted by performing the vibration reduction control”.

Please refer to FIG. 10, which is a block diagram of a motor vibration reduction control circuit of a third embodiment of the present disclosure. The motor vibration reduction control circuit of this embodiment includes:
a vibration amplitude judging unit 801, configured to determine whether an actual vibration amplitude of the motor exceeds a preset amplitude according to a signal output by a vibration sensor installed on the motor;
a phase current adjustment unit 803, configured to determine peak time periods and valley time periods of a cogging torque of the motor, and control an intensity of at least one phase current of the motor during the peak time periods to be higher than an intensity that has not been adjusted by the vibration reduction control, and an intensity of at least one phase current of the motor during the valley time periods to be lower than an intensity that has not been adjusted by the vibration reduction control, when the actual vibration amplitude of the motor exceeds the preset amplitude.

The phase current adjustment unit 803 can control the intensity of the at least one phase current by increasing or decreasing the voltage amplitude of the direct current bus voltage received by the inverter circuit, or control the intensity of the at least one phase current by adjusting the duty cycle of the pulse signal received by the inverter circuit.

In other embodiments, the phase current adjustment unit 803 may further include an analysis unit, which is configured to determine whether the vibration of the motor is caused by the fluctuation of the cogging torque of the motor itself when the actual vibration amplitude exceeds the preset amplitude; the phase current adjustment unit is configured to determine peak time periods and valley time periods of a cogging torque of the motor, and control an intensity of at least one phase current of the motor during the peak time periods to be higher than an intensity that has not been adjusted by the vibration reduction control, and an intensity of at least one phase current of the motor during the valley time periods to be lower than an intensity that has not been adjusted by the vibration reduction control, when the vibration of the motor is caused by the fluctuation of the cogging torque of the motor itself.

It can be understood that the vibration reduction control circuit of the brushless direct current motor of FIG. 9 may also be the vibration reduction control circuit shown in FIG. 10.

The above-described embodiments are only used to illustrate the technical solutions of the present disclosure, rather than to limit them; although the present disclosure has been described in detail with reference to the foregoing embodiments, those skilled in the art should understand that: it is still possible to modify the technical solutions described in the foregoing embodiments, or perform equivalent replacements for some of the technical features; and these modifications or replacements do not make the essence of the corresponding technical solutions deviate from the spirit and scope of the technical solutions of the various embodiments of the present disclosure, and should be included within the protection scope of the present disclosure.

1. A motor vibration reduction control method, characterized in that, the motor vibration reduction control method comprises:
step a, determining whether an actual vibration amplitude of the motor exceeds a preset amplitude;
step b, under the condition that the actual vibration amplitude exceeds the preset amplitude, determining peak time periods and valley time periods of a cogging torque of the motor, and controlling a duty cycle of a pulse signal for driving the motor during the peak time periods to be higher than a duty cycle of the pulse signal during the valley time periods.

2. The motor vibration reduction control method according to claim 1, characterized in that, the step b further comprises increasing the duty cycle of the pulse signal for driving the motor when a load driven by the motor increases, and reducing the duty cycle of the pulse signal when the load driven by the motor decreases.

3. The motor vibration reduction control method according to claim 1, characterized in that, in the step a, whether the actual vibration amplitude exceeds the preset amplitude is determined by judging whether a fluctuation amplitude of a waveform output by a vibration sensor installed on the motor exceeds a preset value.

4. The motor vibration reduction control method according to claim 1, characterized in that, the step b comprises the following steps: under the condition that the actual vibration amplitude exceeds the preset amplitude, further judging whether the vibration of the motor is caused by a fluctuation of the cogging torque of the motor itself; if yes, determining peak time periods and valley time periods of the cogging torque of the motor, and controlling a duty cycle of a pulse signal for driving the motor during the peak time periods to be higher than a duty cycle of the pulse signal during the valley time periods.

5. The motor vibration reduction control method according to claim 4, characterized in that, in the step b, whether the vibration of the motor is caused by the fluctuation of the cogging torque of the motor itself is determined by judging whether an actual vibration frequency of the motor matches a preset frequency.

6. The motor vibration reduction control method according to claim 4, characterized in that, in the step b, whether the vibration of the motor is caused by the fluctuation of the cogging torque of the motor itself is determined by determining whether a number of peak waves, a number of valley waves, or a sum of the two of the actual vibration of the motor within a predetermined period of time matches a corresponding preset number of peak waves, a preset number of valley waves, or a preset sum of the two.

7. The motor vibration reduction control method according to claim 1, characterized in that, the motor is a brushless direct current motor with an inverter circuit, and the pulse signal for driving the motor is a signal output to the inverter circuit.

8. A motor vibration reduction control method, characterized in that, the motor vibration reduction control method comprises:
step a, determining whether an actual vibration amplitude of the motor exceeds a preset amplitude;
step b, under the condition that the actual vibration amplitude exceeds the preset amplitude, determining peak time periods and valley time periods of a cogging torque of the motor, and controlling an intensity of at least one phase current of the motor during the peak time periods to be higher than a first intensity, and an intensity of the at least one phase current of the motor during the valley time periods to be lower than a second intensity, the first intensity being an intensity of the at least one phase current of the motor during the peak time periods before performing the vibration reduction control, and the second intensity being an intensity of the at least one phase current of the motor during the valley time periods before performing the vibration reduction control.

9. The motor vibration reduction control method according to claim 8, characterized in that, the motor is a brushless direct current motor with an inverter circuit, and in the step b, control the intensity of the at least one phase current whose intensity is not zero by increasing or decreasing a voltage amplitude of a direct current bus voltage received by an inverter circuit, or control the intensity of the at least one phase current whose intensity is not zero by adjusting a duty cycle of a pulse signal received by the inverter circuit.

10. The motor vibration reduction control method according to claim 8, characterized in that, further comprises increasing the intensity of the at least one phase current of the motor when a load driven by the motor increases, and decreasing the intensity of the at least one phase current of the motor when the load driven by the motor decreases.

11. The motor vibration reduction control method according to claim 8, characterized in that, the step b comprises the following steps: under the condition that the actual vibration amplitude exceeds the preset amplitude, further judging whether the vibration of the motor is caused by a fluctuation of the cogging torque of the motor itself; if yes, determining peak time periods and valley time periods of the cogging torque of the motor, and controlling an intensity of at least one phase current of the motor during the peak time periods to be higher than a first intensity, and an intensity of the at least one phase current of the motor during the valley time periods to be lower than a second intensity, the first intensity being an intensity of the at least one phase current of the motor during the peak time periods before performing the vibration reduction control, and the second intensity being an intensity of the at least one phase current of the motor during the valley time periods before performing the vibration reduction control.

12. A motor vibration reduction control circuit, characterized in that, the motor vibration reduction control circuit comprises:
a vibration amplitude judging unit, configured to determine whether an actual vibration amplitude of the motor exceeds a preset amplitude according to a signal output by a vibration sensor installed on the motor; and
a phase current adjustment unit, configured to determine peak time periods and valley time periods of a cogging torque of the motor, and control an intensity of at least one phase current of the motor during the peak time periods to be higher than a first intensity, and an intensity of the at least one phase current of the motor during the valley time periods to be lower than a second intensity, under the condition that the actual vibration amplitude exceeds the preset amplitude, the first intensity being an intensity of the at least one phase current of the motor during the peak time periods before performing the vibration reduction control, and the second intensity being an intensity of the at least one phase current of the motor during the valley time periods before performing the vibration reduction control.

13. The motor vibration reduction control circuit according to claim 12, characterized in that, the phase current adjustment unit further comprises an analysis unit, which is configured to judge whether the vibration of the motor is caused by a fluctuation of the cogging torque of the motor itself when the actual vibration amplitude exceeds the preset amplitude; the phase current adjustment unit is configured to determine peak time periods and valley time periods of a cogging torque of the motor, and control an intensity of at least one phase current of the motor during the peak time periods to be higher than a first intensity, and an intensity of the at least one phase current of the motor during the valley time periods to be lower than a second intensity, when the vibration of the motor is caused by the fluctuation of the cogging torque of the motor itself, the first intensity being an intensity of the at least one phase current of the motor during the peak time periods before performing the vibration reduction control, and the second intensity being an intensity of the at least one phase current of the motor during the valley time periods before performing the vibration reduction control.

14. The motor vibration reduction control circuit according to claim 12, characterized in that, the motor is a brushless direct current motor with an inverter circuit, and the phase current adjustment unit controls the intensity of the at least one phase current by increasing or decreasing a voltage amplitude of a direct current bus voltage received by the inverter circuit, or controls the intensity of the at least one phase current by adjusting a duty cycle of a pulse signal received by the inverter circuit.
